(19) United States
(12) Patent Application Publication
(10) Pub. No.: US 2002/0034257 A1
(43) Pub. Date: Mar. 21, 2002

(54) Method for protection of contactless signal transmission from a transmitter to a receiver, and a signal transmission device

(76) Inventor: Nikolas Bergerhoff, Regensburg (DE)

Correspondence Address: Kevin R. Spivak, Morrison & Foerster LLP, 2000 Pennsylvania Ave., NW, Washington, DC, 20006, US

(21) Appl. No.: 09/820,789

(22) Filed: Mar. 30, 2001

(30) Foreign Application Priority Data
Mar. 31, 2000 (DE) 100 161 33.2

(51) Int. Cl. H04L 27/00

(52) U.S. Cl. 375/259

(57) ABSTRACT

For contactless signal transmission, a signal transmitted by a transmitter is subjected to reshaping in such a manner that its reproducibility and/or transmissibility are/is exacerbated, but also in ;uch a manner that the reshaping can be detected in a detector in the receiver. In this way, the signal transmission is protected against the possibility of a deliberately short range between the transmitter and receiver being enlarged by manipulation by an intermediate transmitter/receiver.

This application claims priority to the German Application No. 100 161 33.2 which was filed on Mar. 31, 2000.

### TECHNICAL FIELD OF THE INVENTION

The invention relates to a method for protection of contactless signal transmission from a transmitter to a receiver, and a signal transmission device.

### BACKGROUND OF THE INVENTION

A problem which arises in various applications relating to contactless or wire-free signal transmission between a transmitter and a receiver is that the receiver is intended to respond to a signal received by it or to information contained therein only provided the signal has been transmitted by a predetermined transmitter.

Such protection of signal transmission in access component and identification systems which operate without wires is advantageous, for example, for wire-free operating remote controls. It is particularly advantageous for such protected signal transmission to be used between a motor vehicle and a data storage medium which allows access to the vehicle, without needing to use any mechanical key. In such a so-called passive entry system, the vehicle transmits an interrogation signal. When the interrogation signal is received by a data storage medium, it sends a response signal, which contains code information. The code information contained in the response signals and other signals is checked in the vehicle. If the check is positive, access is allowed to the vehicle.

In order to protect such access systems, the interrogation signal has only a limited range. If this were not the case, the data storage medium would respond even if it were at a relatively long distance 1rom the vehicle, for example in the vehicle holder's dwelling, so that the vehicle could be used without authorization. In order to prevent unauthorized eavesdropping, DE 197 57 294.4 has proposed that the data storage medium be equipped in such a manner that it emits a visual, audible and/or tactile signal, so that the data communication process is noticeable, on receiving an interrogation signal, and/or on transmitting a response s ignal.

FIG. 2 shows a signal generator which, in the illustrated example, produces a sinusoidal wave train 28, which is transmitted via the antenna 8. This wave train propagates over a transmission path 30 and is received in a manner known per se by an inductively acting antenna 14 of a transmitter, thus providing a cosine wave train 32 in the transmitter, for evaluation. The wave train 30 can be received and amplified without any problems by any intermediate conventional receiver and can then be transmitted once again by a conventional transmitter so that, even if the power level transmitted from the antenna 8 is low, the transmitted wave train 30 can be received by a remote antenna 14.

### SUMMARY OF THE INVENTION

In one embodiment of the invention, there is a method for protection of contactless signal transmission from a transmitter to a receiver, with the signal being subjected to reshaping before being transmitted, such that at least one of reproducibility and transmissibility are exacerbated, and the reshaping can be detected by a detector in the receiver.

In one aspect of the invention, the signal being subjected to reshaping in a predetermined sequence in time, and detection being carried out in the receiver to determine whether the reshaping is carried out in the predetermined sequence in time.

In one embodiment of the invention, a signal transmission device, comprising: a transmitter having a reshaping device, which subjects a signal sent from the transmitter for wire-free signal transmission in such a manner that at least one of reproducibility and transmissibility are exacerbated, and a receiver having a detector which supplies an output signal when reshaping is present.

In another aspect of the invention, the signal transmission device, the transmitter including a coding device which activates the reshaping device in a predetermined manner in time, and the receiver including a comparison device which checks whether the received signal is preemphasized in the predetermined manner in time.

In still another aspect of the invention, the signal transmission device, the signal transmission taking place by means of electromagnetic waves.

In yet another aspect of the invention, the signal transmission device, the reshaping device including a diode which is included in a line between a signal generator and an antenna.

In another aspect of the invention, the signal transmission device, the receiver including a sensor which converts a magnetic flux density or a magnetic field strength to an electrical voltage or an electrical current.

In yet another aspect of the invention, the signal transmission device, the reshaping device including a series circuit, comprising a diode and a differentiation element, in a line between a signal generator and an antenna.

### BRIEF DESCRIPTION OF THE DRAWINGS

The invention will be explained in the following text with further details and with reference, by way of example, to schematic drawings, in which:

FIG. 1 shows a block diagram of a signal transmission device according to the invention, and

FIGS. 2 to 4 show signal flowcharts in order to explain the way in which the method according to the invention operates.

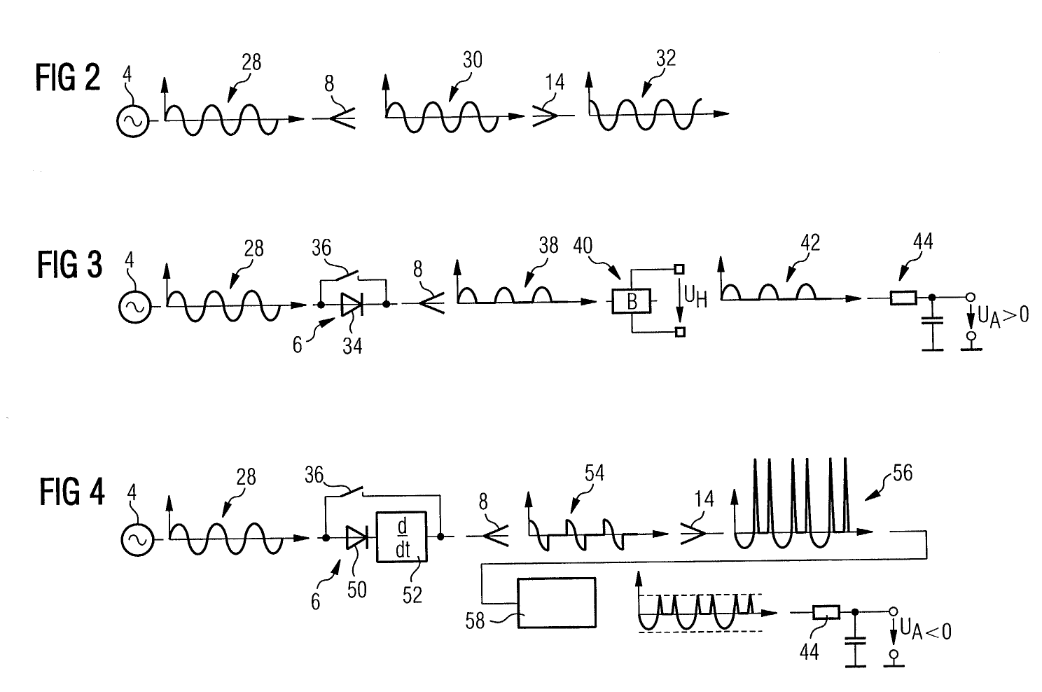

The invention related to a method and a system of contactless signal transmission from a transmitter to a receiver that can be protected, particularly when the contactless communication between the transmitter and the receiver is intended to have only a limited range.

### DETAILED DESCRIPTION OF THE INVENTION

In the method according to the invention, has the signal is subjected to reshaping in such a manner that it is harder to amplify or reproduce it. Furthermore, the signal is advantageously subjected to reshaping in such a manner that its transmissibility is intrinsically made poorer. In addition, the reshaping is carried out in such a manner that it can be detected directly in a detector in the receiver and, in consequence, for example, a “reshaping signal” can be produced which indicates that the signal is coming from a predetermined transmitter. In this context, “reshaping” means that the rate of change of a field variable which describes the signal is not a pure sine-wave or cosine-wave function. In the case of an electromagnetic signal, for example, this means that the sinusoidal electromagnetic wave, which originally has no reshaping, has harmonics added to it. The term “reshaping” used here expressly also includes any change to the originally sinusoidal signal waveform such that the signal which has been subjected to reshaping is no longer a wave which can propagate in the sense of the wave equation, but is now only a variable electromagnetic field. When a transmitter is identified on the basis of code information which is allocated to that transmitter and is transmitted together with the signal by using amplitude, frequency or other modulation, the carrier :signal which the code information can be received, amplified and passed on in the normal manner. In the method according to the invention, the signal is subjected to overall reshaping such that its further transmission is exacerbated, so that eavesdropping and unauthorized relaying are feasible only with difficulty, if at all.

The invention can be to prevent the interception of data communication which is intended for a short transmission path or range, between a transmitter and a receiver. The invention is particularly advantageously suitable for use in motor vehicle access control systems.

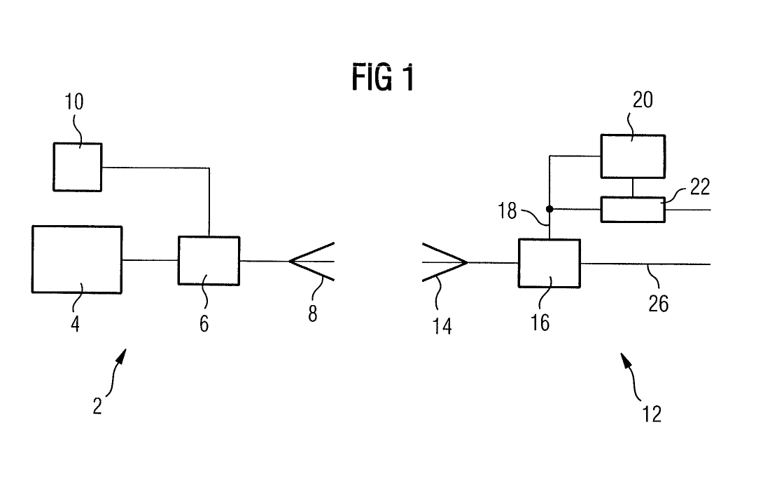

FIG. 1 illustrates a transmitter 2 having a signal generator 4 which is followed by a reshaping device 6, which is in turn connected to an antenna 8. The reshaping device 6 is connected to a coding device 10 in which, for example and as will be explained later, a predetermined time program is stored, by means of which the reshaping device can be started up and shut down.

The receiver 12 has an antenna 14 which is followed by a detector 16 which has a reshaping signal output 18, which is connected to a decoding device 20 and a comparison unit 22. The comparison unit has an output 24. The detector 16 has a signal output 26.

The operation of the described device will be explained in the following text with reference to FIGS. 3 to 4.

FIG. 3 illustrates a modified signal transmission.

The signal generator 4, which produces the sinusoidal wave train 28, is followed by a reshaping device 6 which includes a diode 34 in the signal transmission path between the transmitter 4 and the antenna 8, with a switch 36 connected in parallel with this diode 34.

When the switch 36 is open, the diode 34 results in the sinusoidal wave train 28 being transmitted in the form of the wave train 38, in which the negative half-cycles of the wave train 28 are suppressed, so that only the half-cycles with one polarity are now still transmitted.

The antenna of the receiver in the situation shown in FIG. 3 is formed by a device which includes a sensor 40 and responds more directly to the magnetic flux densities B of the wave train 38 and which, at its output, produces a voltage U_{H} which is dependent on the intensity and direction of the flux density, and appears in the form of the wave train 42. A Hall sensor or a magnetoresistive sensor may be used, by way of example, as the sensor 40. The detector device furthermore includes an output filter 44, which includes a resistor and a capacitor, and at whose output the time mean of the voltage of the wave train 42 can be tapped off as the “reshaping” or output voltage U_{A}, which in this case has a value greater than zero. As can be seen, the occurrence of an output voltage U_{A} at the output of the filter 44 is a clear indication that the wave train 28 has been subjected to reshaping by the switch 36 having been opened. A signal which has been subjected to reshaping and has been transmitted by the transmitter can thus be reliably identified in the receiver.

The particular characteristic of the signal which has been subjected to reshaping is that, as before, the magnitude of the field vector of the magnetic flux density varies, but always points in one direction. In mathematical terms, this means that the field has a DC component. This characteristic is not identified by a conventional, that is to say inductively acting, receiver, since its output voltage is proportional to the rate of change of the magnetic flux density. The information relating to a DC component included in the field is lost by differentiation with respect to time. The reshaping described above would thus be measurable only as a reduction in the field strength. A conventional receiver, that is to say a receiver which operates inductively and not by directly using the Hall effect, could scarcely identify the reshaping at all; it would be measurable only as a reduction in the field strength.

As is evident from what has been stated above, the reproducibility and/or transmissibility of the wave train 38 which has been subjected to reshaping are/is considerably poorer or more difficult than in the case of the wave train 28 since it is impossible by using conventional, inductively acting receivers, to distinguish whether the field strength has been reduced or the reshaping described above has been switched on, and because the reshaping cannot be reproduced by conventional transmitters, either. The reshaping described above is particularly highly suitable for communication paths which are used for communication by means of low-frequency magnetic alternating field. However, high field strengths are required owing to the limited sensitivity of present-day Hall sensors.

FIG. 4 shows a device modified from that in FIG. 3. The reshaping device 6 in the situation in FIG. 4 is formed by a series circuit comprising a diode 50 and a differentiation element 52, once again with a switch 36 connected in parallel with them. When the switch 36 is open, the sinusoidal wave train 28 is converted to a wave train 46 which contains those half-cycles which correspond to the falling edges of a cosine function (or the rising edges if the diode is used the other way round). In the normally inductively acting antenna 14 of a broadband receiver, the half-cycles of the wave train 46 are converted to a wave train 56 which includes half-cycles, each of which is separated by high voltage peaks. The high voltage peaks are then chopped off in a limiter 58, so that, after formation of the mean value in the filter 44, the wave train 60 appears at its output as an output voltage U_{A} which, in the illustrated example, is less than zero. Once again, as is evident from what has been stated above, the reshaping can be detected correctly and transmission of the wave train 54 is made considerably more difficult since a very wide transmission bandwidth is required to transmit this wave train. The reproducibility of the wave train 54 by means of a conventional transmitter is also considerably more difficult than that of a sinusoidal wave train.

The method as shown in FIG. 4 is particularly highly suitable for communication paths which operate with radio-frequency electromagnetic alternating fields for communication transmission. However, it can also be used for low-frequency applications. One advantageous feature is that the method shown in FIG. 4 also operates at low field strengths. A problem, on the other hand, is that the emitted signal has a very broad bandwidth, and can thus interfere with adjacent channels. The reshaping is therefore preferably switched on for limited times.

The transmission methods described with reference to FIGS. 3 and 4 are designed in such a manner that an output voltage occurs on the output filter 44 only when the respective reshaping device has been started up, that is to say when the switch 36 is open. No reshaping is produced when the switch 36 is closed.

Depending on the desired security level, the signal transmission device can be constructed in a simple manner such that the switch 36 in the transmitter is always open (or the switch is omitted entirely), so that the receiver is designed to receive only signals which have been subjected to reshaping and, as described, to respond to them. In a further embodiment, the switch 36 can be operated by the coding device 10 (FIG. 1) in a predetermined time sequence, and the predetermined time sequence can be stored in the decoding device 20 in the receiver. When the receiver for the first time receives a signal which has been subjected to reshaping, a reshaping signal appears at the reshaping output 18, in response to which the program in the decoding device 20, which corresponds to the coding device 10, starts. It is then possible to determine in the comparison unit 22 whether the reshaping is in the predetermined time sequence and, if the comparison is positive, the output of the comparison unit 22 emits an appropriate signal. This allows the reshaping to be provided with additional codings.

It is also self-evident that the receiver can in each case be designed such that it processes signals transmitted when the switch 36 is closed in the conventional manner, and also responds to the coding. In the case of the embodiment shown in FIG. 3, there would then be a conventional receiving antenna in addition to the sensor 40.

The device according to the invention can be modified in a large number of ways. It can be carried out using other reshaping devices and/or reshaping methods. Furthermore, it is not essential to use electromagnetic waves in the frequency bands that are normally used. The invention can also use ultrasound, infrared or other contactless transmission methods, with appropriate, suitable, reshaping methods then being used.

What is claimed is:

1. A method for protection of contactless signal transmission from a transmitter to a receiver, with the signal being subjected to reshaping before being transmitted, such that at least one of reproducibility and transmissibility are exacerbated, and the reshaping can be detected by a detector in the receiver.

2. The method as claimed in claim 1, the signal being subjected to reshaping in a predetermined sequence in time, and detection being carried out in the receiver to determine whether the reshaping is carried out in the predetermined sequence in time.

3. A signal transmission device, comprising:
a transmitter having a reshaping device, which subjects a signal sent from the transmitter for wire-free signal transmission in such a manner that at least one of reproducibility and transmissibility are exacerbated; and
a receiver having a detector which supplies an output signal when reshaping is present.

4. The signal transmission device as claimed in claim 3, the transmitter including a coding device which activates the reshaping device in a predetermined manner in time, and the receiver including a comparison device which checks whether the received signal is preemphasized in the predetermined manner in time.

5. The signal transmission device as claimed in claim 3, the signal transmission taking place by means of electromagnetic waves.

6. The signal transmission device as claimed in claim 3, the reshaping device including a diode which is included in a line between a signal generator and an antenna.

7. The signal transmission device as claimed in claim 3, the receiver including a sensor which converts a magnetic flux density or a magnetic field strength to an electrical voltage or an electrical current.

8. The signal transmission device as claimed in claim 3, the reshaping device including a series circuit, comprising a diode and a differentiation element, in a line between a signal generator and an antenna.
